(19) United States
(12) Patent Application Publication
(10) Pub. No.: US 2010/0013872 A1
(43) Pub. Date: Jan. 21, 2010

(54) LIQUID CRYSTAL DISPLAY DEVICE

(76) Inventors: Takeshi Masuda, Osaka (JP); Tokihiko Shinomiya, Osaka (JP)

Correspondence Address: HARNESS, DICKEY & PIERCE, P.L.C., P.O. BOX 8910, RESTON, VA, 20195, US

(21) Appl. No.: 12/449,529

(22) PCT Filed: Feb. 14, 2008
(86) PCT No.: PCT/JP2008/052401

§ 371 Date: Aug. 12, 2009

(30) Foreign Application Priority Data
Jun. 11, 2007 (JP) 2007-154201

(51) Int. Cl. G09G 3/36; G09G 5/00

(52) U.S. Cl. 345/691; 345/102

(57) ABSTRACT

One embodiment of the present invention discloses a liquid crystal display device, and more particularly a transmissive-type liquid crystal display device including a backlight on a back of a panel. The liquid crystal display device includes a gray scale signal generating portion including an input image luminance level analyzing circuit that obtains luminance level distributions of respective colors based on RGB image signals, a correction coefficient calculating circuit that calculates correction coefficients based on the luminance level distributions of the respective colors, and an image signal correcting circuit that corrects luminance levels indicated by the RGB image signals, based on the correction coefficients; and an amount-of-backlight-light control circuit that adjusts amounts of lights emitted from LEDs for the respective colors based on the correction coefficients. In the correction coefficient calculating circuit, correction coefficients are calculated such that a difference in luminance level distribution between the RGB colors is reduced by corrections to luminance levels. In the amount-of-backlight-light control circuit, the amounts of lights emitted for the respective colors are adjusted such that changes in luminance levels and changes in the amounts of lights emitted are mutually cancelled out.

### TECHNICAL FIELD

The present invention relates to a liquid crystal display device, and more particularly to a transmissive-type liquid crystal display device including a backlight on a back of a panel.

### BACKGROUND ART

Liquid crystal display devices have features such as slimness, low power consumption, and high definition, and by recent development of manufacturing technology, an increase in a size of a screen has proceeded. Hence, for televisions in which conventionally mainly a CRT (Cathode Ray Tube) is adopted, adoption of a liquid crystal display device has also proceeded. However, an image displayed on a liquid crystal display device has problems that a contrast feeling (the difference in lightness between a bright portion and a dark portion perceived by people) is lower than that of an image displayed on a CRT and a color nuance shifts depending on a visual angle (viewing angle). Note that the expression “color nuance shifts” refers to that when a color is represented by, for example, three primary colors RGB, the ratio of the RGB colors changes.

First, the point that “in a liquid crystal display device, a contrast feeling obtained from a display image is lower” will be described with reference to FIG. 19. FIG. 19 is a diagram for describing the difference in contrast feeling between a liquid crystal display device and a CRT. In the CRT, the peak luminance (the brightest luminance) dynamically changes according to a value of an average luminance level (an average value of luminances indicated by image signals for one frame). More specifically, when the average luminance level is high (when the entire screen is bright) the peak luminance is low, and when the average luminance level is low (when the entire screen is dark) the peak luminance is high. In this manner, the contrast between a bright area and a dark area becomes remarkable on the screen and accordingly a contrast feeling obtained from a display image increases. On the other hand, in the liquid crystal display device, regardless of the value of an average luminance level, the peak luminance has a constant value. This is because, in the liquid crystal display device, the intensity of light radiated from a backlight is generally kept constant. Therefore, since the peak luminance has a constant value in the liquid crystal display device, the contrast feeling is lower than that obtained by the CRT.

Next, the point that “in a liquid crystal display device, a color nuance shifts depending on a visual angle” will be described with reference to FIG. 20. In a liquid crystal display device adopting a vertical alignment scheme (VA mode), the relationship between the gray scale level of an input image signal and the luminance of a display image is shown in FIG. 20A and the relationship between the luminance level of an input image signal and the luminance of a display image is shown in FIG. 20B. Note that, in FIGS. 20A and 20B, for the luminance of a display image, a value standardized at a maximum luminance (standardized luminance) is shown. As shown in FIGS. 20A and 20B, even when gray scale levels or luminance levels of the input image signal are identical, the standardized luminance varies between when a person sees an image from a front direction and when the person sees the image from a 60-degree direction (the front direction is assumed to be 0 degree). For example, when the gray scale levels of input image signals are “R=255, G=128, and B=60”, the standardized luminances for when a person sees an image from the front direction are “R=1.0, G=0.22, and B=0.04”. On the other hand, the standardized luminances for when the person sees the image from the 60-degree direction are “R=1.0, G=0.34, and B=0.17”. Therefore, in the liquid crystal display device, a color nuance shifts depending on the visual angle.

Meanwhile, Japanese Unexamined Patent Publication No. 2005-258404 discloses an invention about a liquid crystal display device that controls the luminance of illumination light from a backlight according to a display image to increase a contrast feeling and suppress a shift in color nuance depending on the visual angle. FIG. 21 is a block diagram showing an overall configuration of this liquid crystal display device. As shown in FIG. 21, the liquid crystal display device includes a controller 1110, a display data changing circuit 1120, an amount-of-backlight-light control circuit 1121, an optical sensor 1122, a liquid crystal display unit 1130, and a backlight 1131. Based on a detection signal from the optical sensor 1122 that detects the intensities of RGB color lights radiated from the backlight 1131 and an image signal (input image signal) to be transmitted from a personal computer, a television tuner, or the like, the controller 1110 obtains an amount by which the value of the image signal is to be changed (data conversion amount) and amounts of lights emitted from the backlight 1131 (intensities of lights radiated from the backlight). The display data changing circuit 1120 changes (corrects) the value of the input image signal on a color-by-color basis, based on a change instruction from the controller 1110 and outputs an image signal on the basis of the values after the change. The amount-of-backlight-light control circuit 1121 adjusts the amounts of lights emitted from the backlight 1131 on a color-by-color basis, based on an instruction from the controller 1110.

FIG. 22 is a block diagram showing an internal configuration of the aforementioned controller 1110. The controller 1110 includes display content analyzing circuits 1111, 1112, and 1113 provided for the respective RGB colors to analyze contents of an input image signal; and an image quality controller 1114 for determining a data conversion amount and amounts of light emitted from the backlight 1131, based on results of the analysis. The display content analyzing circuits 1111, 1112, and 1113 are respectively configured by maximum and minimum detecting circuits 1111-1, 1121-1, and 1131-1, each of which obtains a maximum value and a minimum value (of a luminance value) from data for one frame (for one screen); and registers 1111-2, 1121-2, and 1131-2, each of which holds data on the maximum value and the minimum value. Note that data in a register is outputted from the controller 1110 as a content image characteristic signal and is rewritten (updated) on the basis of a frame period. The image quality controller 1114 is configured by an optical sensor detecting circuit 1114-2 that receives a detection signal from the optical sensor 1122; an amount-of-control data memory 1114-3 that holds gray-scale-to-luminance characteristics (γ characteristics) of the liquid crystal display unit 1130 and light emission characteristics of the backlight 1131; and an amount-of-control determining circuit 1114-1 that outputs a display data change instruction signal and a backlight emission instruction signal based on information held in the optical sensor detecting circuit 1114-2 and the amount-of-control data memory 1114-3 or a content image characteristic signal.

As shown in FIG. 2, the backlight 1131 is configured by a light diffusion plate 51 and a backlight frame 52. The backlight frame 52 is provided with red LEDs (light-emitting diodes) 53R, green LEDs 53G, and blue LEDs 53B. The LEDs 53R, 53G, and 53B for the respective RGB colors are controlled independently of one another by the aforementioned amount-of-backlight-light control circuit 1121 (the amounts of lights emitted are adjusted).

With such a configuration as described above, in the liquid crystal display device, the value of an input image signal is converted for each color of RGB and the amounts of lights emitted from the backlight 1131 are adjusted for each color of RGB. For example, for input image signals for a certain frame, when all the gray scale values of red data are less than or equal to 128 (gray scale values are assumed to range from 0 to 255) and the gray-scale-to-luminance characteristic (γ characteristic) of the liquid crystal display unit 1130 is “2.2”, the maximum value of luminance to be displayed is “one-quarter” or less of “255” (the maximum gray scale value). In such a case, the amount of light emitted from the backlight 1131 is reduced to “one-quarter” or less of that at normal times and the gray scale value of display data (red data) is doubled (the gray scale is changed from 128 to the order of 255), whereby a contrast feeling is substantially increased.

In the liquid crystal display device disclosed in Japanese Unexamined Patent Publication No. 2005-258404, when, for example, frequency distributions of gray scale values (hereinafter, referred to as the “gray scale distributions”) on the basis of an input image signal are such as those shown in FIG. 23A, gray scale distributions after data conversion are such as those shown in FIG. 23B. In this manner, RGB color data units are converted such that a difference in gray scale distribution between RGB colors is reduced. In a display image on the basis of an image signal after the data conversion, a difference in luminance shift depending on the visual angle between the RGB colors is reduced and a shift in color nuance is reduced.

[Patent Document 1] Japanese Unexamined Patent Publication No. 2005-258404

### DISCLOSURE OF THE INVENTION

### Problems to be Solved by the Invention

Japanese Patent Application Laid-Open No. 2005-258404, however, does not disclose a specific method for reducing a difference in gray scale distribution between RGB colors. Also, in the example shown in FIG. 23, taking a look at red data and green data, although before data conversion the average values of gray scale values of the red and green data substantially match each other, after data conversion a difference occurs in the average values of gray scale values of the red and green data. This is considered to result from that the controller 1110 performs data conversion based on gray scale distributions of the respective RGB colors obtained from an input image signal, such that the amounts of lights emitted from the LEDs for the respective RGB colors in the backlight 1131 are reduced as much as possible and the gray scale values of the respective RGB colors are increased as much as possible. Hence, it is considered that by data conversion a difference in gray scale distribution between the RGB colors increases and thus a shift in color nuance depending on the visual angle increases. For example, when gray scale distributions on the basis of an input image signal are such as those shown in FIG. 24A, gray scale distributions after data conversion are considered to become those shown in FIG. 24B.

Therefore, an object of the present invention is to provide a liquid crystal display device capable of suppressing a shift in color nuance depending on the visual angle while increasing a contrast feeling obtained from a display image.

### Means for Solving the Problems

A first aspect of the present invention is directed to a liquid crystal display device that has a display unit including a plurality of pixels and a backlight that radiates lights of a plurality of primary colors onto the display unit from a back of the display unit; receives image signals indicating luminance levels of the plurality of primary colors for each pixel from an external source; and displays an image based on the plurality of primary colors on the display unit based on the image signals, the liquid crystal display device including:
a luminance level distribution obtaining portion that obtains, based on the image signals, number-of-pixel distributions by luminance level that represent distributions of the number of pixels by luminance level for the respective plurality of primary colors;
an image signal correcting portion that corrects, for each color of the plurality of primary colors, the luminance levels indicated by the image signals such that a difference in the number-of-pixel distribution by luminance level between the plurality of primary colors is reduced, based on the number-of-pixel distributions by luminance level for the respective plurality of primary colors obtained by the luminance level distribution obtaining portion; and
a light emission intensity adjusting portion that adjusts, for each color of the plurality of primary colors, intensities of the lights radiated from the backlight, according to magnitudes of the corrections made to the luminance levels for each color of the plurality of primary colors by the image signal correcting portion, wherein
the light emission intensity adjusting portion adjusts the intensity of light radiated from the backlight such that the intensity of light is lowered for a primary color whose luminance level is corrected to be higher by the image signal correcting portion.

According to a second aspect of the present invention, in the first aspect of the present invention,
the light emission intensity adjusting portion adjusts the intensity of light radiated from the backlight such that the intensity of light is heightened for a primary color whose luminance level is corrected to be lower by the image signal correcting portion.

According to a third aspect of the present invention, in the first aspect of the present invention,
the liquid crystal display device further includes a correction coefficient calculating portion that calculates, for each color of the plurality of primary colors, correction coefficients for determining the magnitudes of the corrections to the luminance levels, based on the number-of-pixel distributions by luminance level for the respective plurality of primary colors, wherein
the image signal correcting portion corrects, for each color of the plurality of primary colors, the luminance levels indicated by the image signals, based on the correction coefficients calculated for each color of the plurality of primary colors, and
the light emission intensity adjusting portion adjusts, for each color of the plurality of primary colors, intensities of the lights radiated from the backlight, based on the correction coefficients calculated for each color of the plurality of primary colors.

According to a fourth aspect of the present invention, in the third aspect of the present invention,
the liquid crystal display device further includes an overlapping frequency obtaining portion that obtains, as an overlapping frequency, numbers of pixels included in a region where, when the number-of-pixel distributions by luminance level for the respective plurality of primary colors are superimposed on one another, all of the plurality of primary colors overlap one another, wherein
the correction coefficient calculating portion calculates the correction coefficients such that the overlapping frequency is maximized.

According to a fifth aspect of the present invention, in the third aspect of the present invention,
the liquid crystal display device further includes a highest-frequency luminance level obtaining portion that obtains, for each color of the plurality of primary colors, a luminance level at which a number of pixels is largest, as a highest-frequency luminance level, based on the number-of-pixel distributions by luminance level for the respective plurality of primary colors, wherein
the correction coefficient calculating portion calculates the correction coefficients such that the highest-frequency luminance levels of the respective plurality of primary colors are equal to one another.

According to a sixth aspect of the present invention, in the third aspect of the present invention,
the liquid crystal display device further includes an average luminance level obtaining portion that obtains, for each color of the plurality of primary colors, an average value of luminance levels as an average luminance level, based on the number-of-pixel distributions by luminance level for the respective plurality of primary colors, wherein
the correction coefficient calculating portion calculates the correction coefficients such that the average luminance levels of the respective plurality of primary colors are equal to one another.

According to a seventh aspect of the present invention, in the third aspect of the present invention,
the correction coefficient calculating portion calculates the correction coefficients such that luminance levels indicated by image signals after corrections made by the image signal correcting portion are higher or equal to luminance levels indicated by image signals before the corrections.

According to an eighth aspect of the present invention, in the third aspect of the present invention,
the correction coefficient calculating portion calculates the correction coefficients under a condition that luminance levels indicated by image signals after corrections made by the image signal correcting portion are less than or equal to maximum values of luminance levels displayable on the display unit.

According to a ninth aspect of the present invention, in the first aspect of the present invention,
the backlight is configured to be able to radiate, for the plurality of primary colors, lights with different intensities onto a plurality of predetermined regions, respectively, which are included in the display unit,
the luminance level distribution obtaining portion obtains, for each region of the plurality of regions, number-of-pixel distributions by luminance level,
the image signal correcting portion corrects, for each region of the plurality of regions, the luminance levels indicated by the image signals, and
the light emission intensity adjusting portion adjusts, for each region of the plurality of regions, the intensities of the lights.

### Effects of the Invention

According to the first aspect of the present invention, for number-of-pixel distribution conditions by luminance level, luminance levels indicated by image signals are corrected for each primary color such that a difference in the distribution conditions between the plurality of primary colors is reduced. In addition, according to the corrections to luminance levels, the intensities of lights radiated from the backlight are adjusted for each primary color. The intensities of lights are adjusted such that changes in the luminance levels indicated by the image signals and changes in the intensities of lights radiated from the backlight are mutually cancelled out. Accordingly, while a contrast feeling obtained from a display image is increased, a shift in color nuance depending on the visual angle is suppressed.

According to the second aspect of the present invention, as with the first aspect of the present invention, while a contrast feeling obtained from a display image is increased, a shift in color nuance depending on the visual angle is suppressed.

According to the third aspect of the present invention, correction coefficients for determining magnitudes of corrections to luminance levels are calculated by the correction coefficient calculating portion, and based on the correction coefficients corrections to the luminance levels and adjustments to the intensities of lights are made. Hence, only by calculating correction coefficients, corrections to luminance levels and adjustments to the intensities of lights are easily made.

According to the fourth aspect of the present invention, correction coefficients are calculated such that numbers of pixels included in a region where, when number-of-pixel distributions by luminance level for the respective plurality of primary colors are superimposed on one another, all of the plurality of primary colors overlap one another are maximized. Based on the correction coefficients, corrections to luminance levels and adjustments to the intensities of lights are made. Accordingly, a shift in color nuance depending on the visual angle is effectively suppressed.

According to the fifth aspect of the present invention, correction coefficients are calculated for each primary color such that highest-frequency luminance levels, each of which is a luminance level of each of the plurality of primary colors at which the number of pixels is largest, are equal between the plurality of primary colors. According to this, correction coefficients are calculated using highest-frequency luminance levels of the respective primary colors. Hence, correction coefficients can be calculated by a relatively simple configuration.

According to the sixth aspect of the present invention, correction coefficients are calculated for each primary color such that average luminance levels, each of which is an average value of luminance levels, are equal between the plurality of primary colors. According to this, correction coefficients are calculated using average luminance levels of the respective primary colors. Hence, correction coefficients can be calculated by a relatively simple configuration.

According to the seventh aspect of the present invention, the luminance levels of the respective primary colors are not reduced by corrections. Here, if the luminance level of a certain primary color is reduced by a correction, then the intensity of light of the primary color radiated from the backlight needs to be increased; however, there is an upper limit to the intensity of light that can be radiated. Thus, when the luminance level is reduced by a correction to less than a predetermined value, the intensity of light cannot be increased to a desired intensity. Regarding this point, according to the present invention, since adjustments are made so as to reduce the intensities of lights, changes in luminance levels indicated by image signals and changes in the intensities of lights radiated from the backlight are mutually cancelled out reliably, and accordingly, a contrast feeling obtained from a display image is reliably increased.

According to the eighth aspect of the present invention, luminance levels indicated by image signals after correction do not exceed the maximum values of displayable luminance levels. Accordingly, an image on the basis of luminance levels obtained after correction is reliably displayed.

According to the ninth aspect of the present invention, the backlight can radiate lights with different intensities onto a plurality of regions, respectively, in the display unit. Also, the luminance level distribution obtaining portion, the image signal correcting portion, and the light emission intensity adjusting portion perform processes for each region of the plurality of regions. Accordingly, even when an image in which the color nuance varies from region to region is displayed, since corrections to luminance levels are made for each region, a shift in color nuance depending on the visual angle is more effectively suppressed.

### BRIEF DESCRIPTION OF THE DRAWINGS

FIG. 1 is a block diagram showing an overall configuration of a liquid crystal display device according to a first embodiment of the present invention.

FIG. 2 is a schematic diagram showing a configuration of a backlight in the first embodiment.

FIGS. 3A to 3C are diagrams showing luminance level distributions of input image signals in the first embodiment.

FIG. 4 is a diagram showing an overlapping frequency of luminance levels between RGB color data units before corrections to luminance levels in the first embodiment.

FIGS. 5A to 5C are diagrams showing luminance level distributions after corrections to luminance levels in the first embodiment.

FIG. 6 is a diagram showing an overlapping frequency of luminance levels between RGB color data units after corrections to luminance levels in the first embodiment.

FIGS. 7A to 7C are diagrams showing luminance level distributions of input image signals in a first variant of the first embodiment.

FIG. 8 is a diagram showing an overlapping frequency of luminance levels between RGB color data units before corrections to luminance levels in the first variant.

FIGS. 9A to 9C are diagrams showing luminance level distributions for describing setting of upper limit values for the values of correction coefficients in the first variant.

FIG. 10 is a diagram showing an overlapping frequency for describing setting of upper limit values for the values of correction coefficients in the first variant.

FIGS. 11A to 11C are diagrams showing luminance level distributions after corrections to luminance levels in the first variant.

FIG. 12 is a diagram showing an overlapping frequency of luminance levels between RGB color data units after corrections to luminance levels in the first variant.

FIG. 13 is a block diagram showing an overall configuration of a liquid crystal display device according to a second embodiment of the present invention.

FIGS. 14A to 14C are diagrams showing luminance level distributions of input image signals in the second embodiment.

FIGS. 15A to 15C are diagrams showing luminance level distributions after corrections to luminance levels in the second embodiment.

FIGS. 16A to 16C are diagrams showing luminance level distributions of input image signals in a first variant of the second embodiment.

FIGS. 17A to 17C are diagrams showing luminance level distributions for describing setting of upper limit values for the values of correction coefficients in the first variant.

FIGS. 18A to 18C are diagrams showing luminance level distributions after corrections to luminance levels in the first variant.

FIG. 19 is a diagram for describing a difference in contrast feeling between a liquid crystal display device and a CRT in a conventional example.

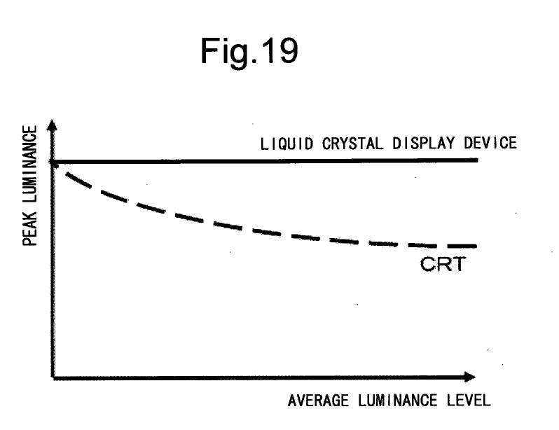

FIGS. 20A and 20B are diagrams showing relationships between the gray scale level and luminance level of an input image signal and the luminance of a display image in the conventional example.

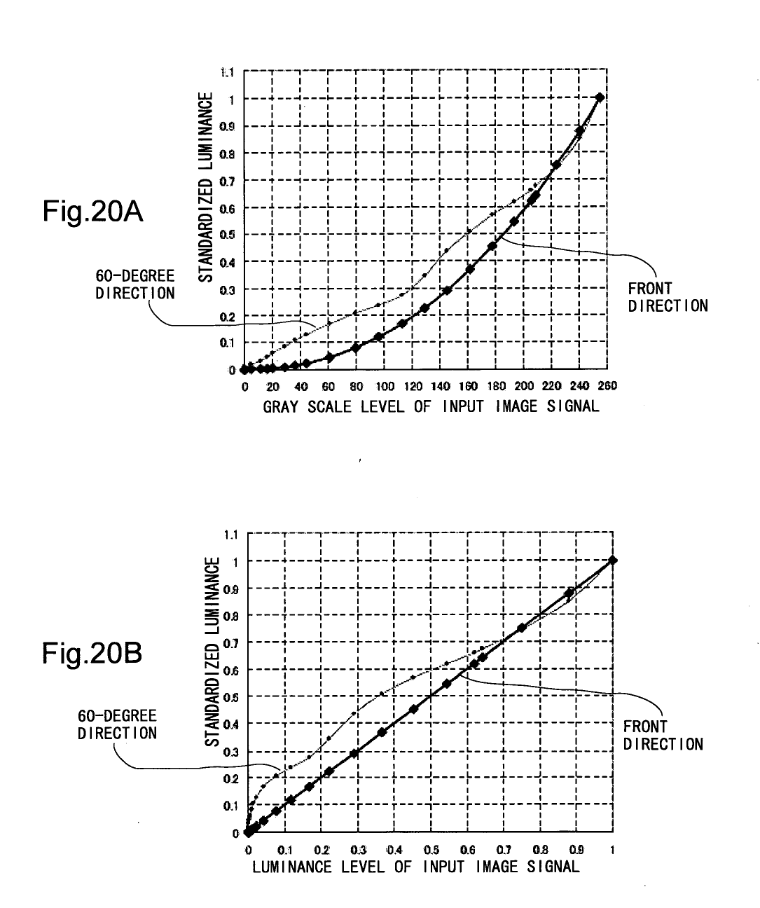

FIG. 21 is a block diagram showing an overall configuration of a liquid crystal display device in the conventional example.

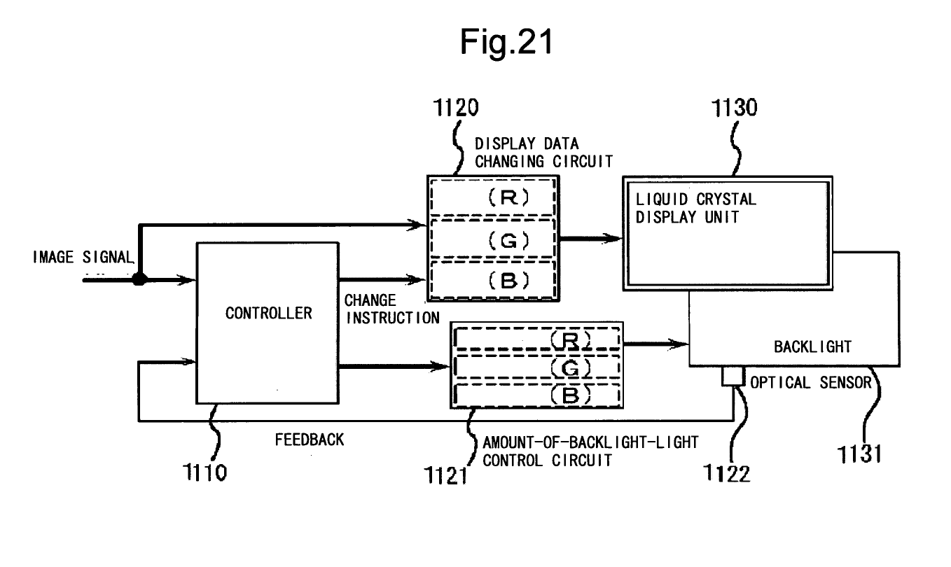

FIG. 22 is a block diagram showing an internal configuration of a controller in the conventional example.

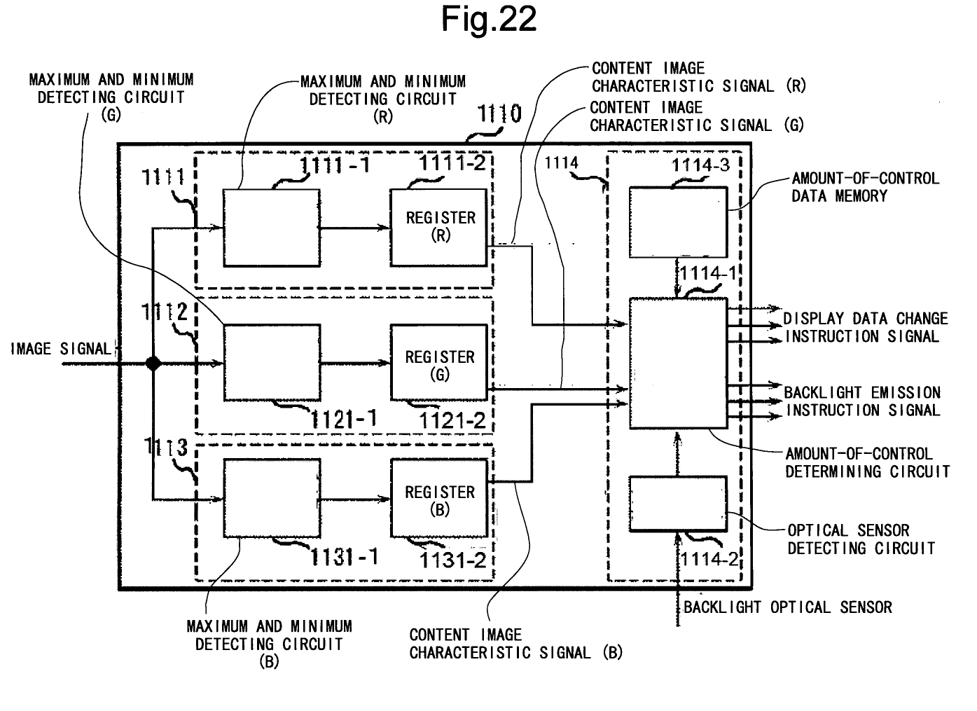

FIGS. 23A and 23B are diagrams showing gray scale distributions before and after data conversion in the conventional example.

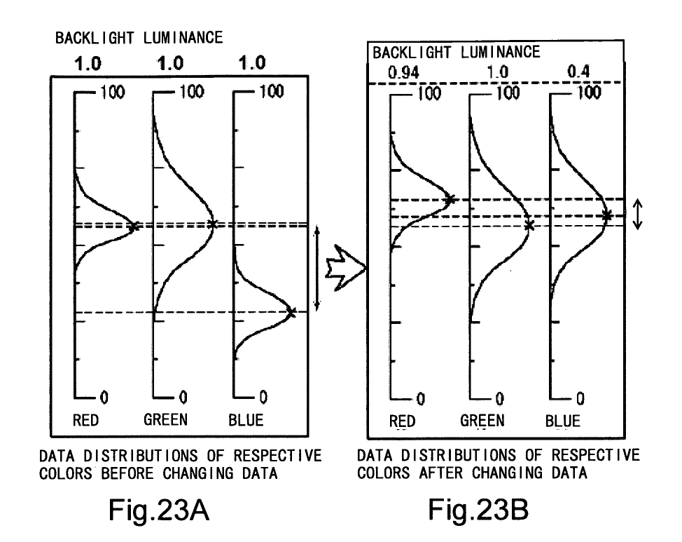

FIGS. 24A and 24B are diagrams showing another example of gray scale distributions before and after data conversion in the conventional example.

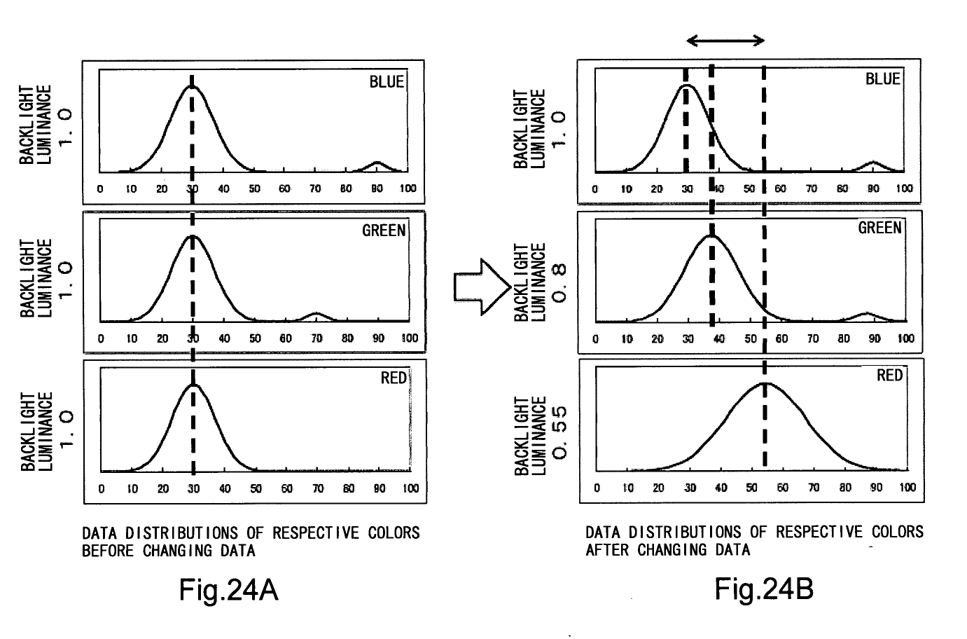

### DESCRIPTION OF THE REFERENCE NUMERALS

52: Backlight frame
53R: Red LED (light-emitting diode)
53G: Green LED (light-emitting diode)
53B: Blue LED (light-emitting diode)
100: Gray scale signal generating portion
120: Input image luminance level analyzing circuit
140: Correction coefficient calculating circuit
160: Image signal correcting circuit
200: Display unit
500: Backlight
600: Amount-of-backlight-light control circuit
1201: Highest-frequency luminance level obtaining portion
1401: Overlapping frequency obtaining portion
Ba(R), Ba(G), and Ba(B): Amount of light emitted from the backlight
Ia(R), Ia(G), and Ia(B): Luminance level after correction
Ib(R), Ib(G), and Ib(B): Luminance level before correction
P(R), P(G), and P(B): Correction coefficient

### BEST MODE FOR CARRYING OUT THE INVENTION

An embodiment of the present invention will be described below with reference to the accompanying drawings.

### 1. First Embodiment

<1.1 Overall Configuration and Operation>

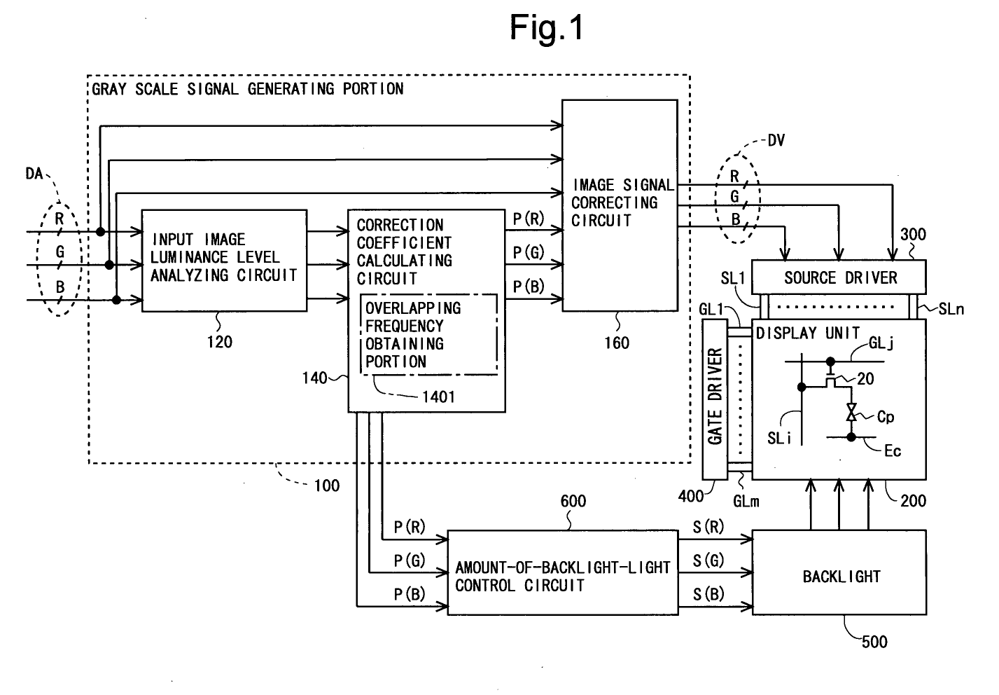

FIG. 1 is a block diagram showing an overall configuration of a liquid crystal display device according to a first embodiment of the present invention. The liquid crystal display device includes a gray scale signal generating portion 100, a display unit (liquid crystal display panel) 200, a source driver (video signal line drive circuit) 300, a gate driver (scanning signal line drive circuit) 400, a backlight 500, and an amount-of-backlight-light control circuit (light emission intensity adjusting portion) 600.

The gray scale signal generating portion 100 receives digital image signals DA (RGB image signals) transmitted from an external source and outputs gray scale signals DV indicating gray scale values of respective RGB color data units and correction coefficients P(R), P(G), and P(B) for adjusting the amounts of lights emitted from the backlight 500 (the intensities of lights radiated from the backlight 500), based on frequency distributions of luminance levels (luminance values) (hereinafter, referred to as the “luminance level distributions”) of the respective RGB color data units for one frame. Note that the gray scale signal generating portion 100 will be described in detail later.

The display unit 200 includes a plurality of (n) source bus lines (video signal lines) SL1 to SLn, a plurality of (m) gate bus lines (scanning signal lines) GL1 to GLm, and a plurality of (n×m) pixel formation portions respectively provided at intersections of the plurality of source bus lines SL1 to SLn and the plurality of gate bus lines GL1 to GLm. The pixel formation portions are arranged in a matrix to configure a pixel array. Each pixel formation portion is composed of a TFT 20 which is a switching element having a gate terminal connected to a gate bus line GLj passing through a corresponding intersection and having a source terminal connected to a source bus line SLi passing through the intersection; a pixel electrode connected to a drain terminal of the TFT 20; a common electrode Ec which is a counter electrode provided for the plurality of pixel formation portions in a shared manner; and a liquid crystal layer provided for the plurality of pixel formation portions in a shared manner and sandwiched between the pixel electrode and the common electrode Ec. By a liquid crystal capacitance formed by the pixel electrode and the common electrode Ec, a pixel capacitance Cp is configured.

The source driver 300 receives the gray scale signals DV outputted from the gray scale signal generating portion 100 and a timing signal (for the source driver) outputted from a timing generator and applies a driving video signal to each of the source bus lines SL1 to SLn to charge the pixel capacitances Cp of the respective pixel formation portions in the display unit 200. The gate driver 400 repeats an application of an active scanning signal to each of the gate bus lines GL1 to GLm in a cycle of one vertical scanning period, based on a timing signal (for the gate driver) outputted from the timing generator.

The amount-of-backlight-light control circuit 600 outputs backlight control signals S(R), S(G), and S(B) for adjusting (controlling) the amounts of lights emitted from LEDs for the RGB colors, as will be described later, based on the correction coefficients P(R), P(G), and P(B) outputted from the gray scale signal generating portion 100.

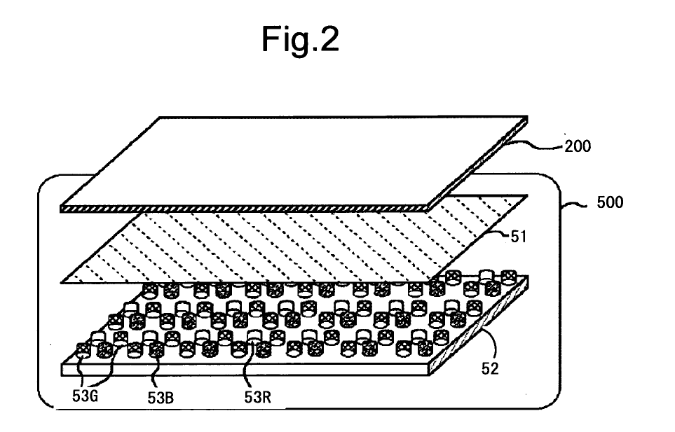

The backlight 500 radiates lights from the back of the display unit 200 based on the backlight control signals S(R), S(G), and S(B) outputted from the amount-of-backlight-light control circuit 600. FIG. 2 is a schematic diagram showing a configuration of the backlight 500 according to the present embodiment. As shown in FIG. 2, the backlight 500 is composed of an optical sheet 51 such as a light diffusion plate or prism sheet; and a backlight frame 52. The backlight frame 52 is provided with red LEDs (light-emitting diodes) 53R, green LEDs 53G, and blue LEDs 53B. The optical sheet 51 is arranged so as to be sandwiched between the display unit 200 and the backlight frame 52. The LEDs 53R, 53G, and 53B for the respective RGB colors are controlled independently of one another by the aforementioned backlight control signals S(R), S(G), and S(B) outputted from the amount-of-backlight-light control circuit 600 (the amounts of lights emitted are adjusted). Note that in the present embodiment, lights with an equal intensity are radiated onto the entire display unit 200 for each color of RGB.

With such a configuration as described above, a driving video signal is applied to each of the source bus lines SL1 to SLn, a scanning signal is applied to each of the gate bus lines GL1 to GLm, and lights are radiated onto the display unit 200 from the backlight 500, whereby an image is displayed on the display unit 200.

<1.2 Configuration and Operation of the Gray Scale Signal Generating Portion>

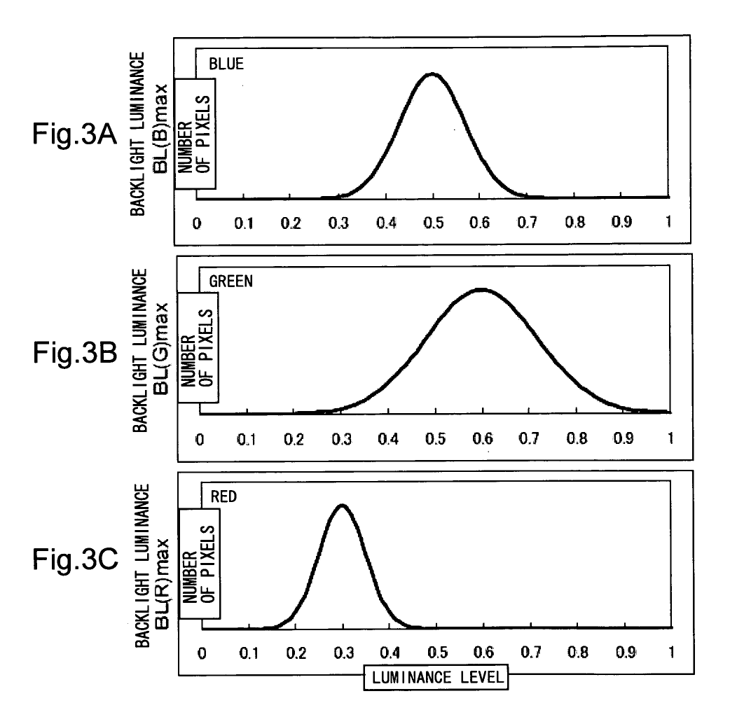

As shown in FIG. 1, the gray scale signal generating portion 100 includes input image luminance level analyzing circuit 120, a correction coefficient calculating circuit 140, and an image signal correcting circuit 160. The correction coefficient calculating circuit 140 includes an overlapping frequency obtaining portion 1401. The input image luminance level analyzing circuit 120 receives digital image signals DA (RGB image signals) transmitted from an external source and obtains luminance level distributions of respective RGB color data units. Note that the luminance level distributions indicate, for example, as shown in FIGS. 3A to 3C, the number of data units (the number of pixels) for each luminance level for pixel data units for one frame. The correction coefficient calculating circuit 140 calculates, based on the luminance level distributions obtained by the input image luminance level analyzing circuit 120, correction coefficients P(R) , P(G), and P(B) for correcting the luminance levels of the RGB color data units and adjusting the amounts of lights emitted from the backlight 500, and outputs them. At that time, the overlapping frequency obtaining portion 1401 obtains an “overlapping frequency”, as will be described later. The image signal correcting circuit 160 corrects, based on the correction coefficients P(R), P(G), and P(B) calculated by the correction coefficient calculating circuit 140, the luminance levels of the RGB color data units on the basis of the digital image signals DA, and outputs gray scale signals DV indicating gray scale values corresponding to the luminance levels obtained after the corrections. Note that in the present embodiment, a luminance level distribution obtaining portion is implemented by the input image luminance level analyzing circuit 120.

<1.3 Corrections to Luminance Levels and Adjustments to the Amounts of Lights Emitted from the Backlight>

Next, corrections to luminance levels and adjustments to the amounts of lights emitted from the backlight 500 will be described. In the present embodiment, luminance levels indicated by digital image signals DA transmitted from an external source are corrected for each color of RGB. Then, gray scale signals DV indicating gray scale values corresponding to the luminance levels obtained after the corrections are transmitted to the source driver 300 from the gray scale signal generating portion 100. In addition, the intensities of lights radiated (the amounts of lights emitted) from the backlight 500 are adjusted according to the degrees of the corrections to luminance levels (the rates of change in luminance levels by corrections).

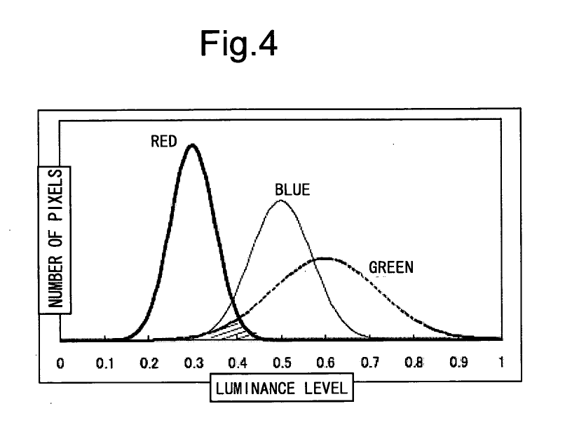

Here, it is assumed that when digital image signals DA for one frame are inputted (the digital image signals are hereinafter referred to as the “input image signals”) luminance level distributions of respective RGB color data units are such as those shown in FIGS. 3A to 3C. At this time, when the luminance level distributions shown in FIGS. 3A to 3C are represented in one drawing, there is a portion where the luminance level distributions of the respective RGB colors overlap one another, such as a portion indicated by oblique lines in FIG. 4. This oblique line portion indicates that, in each of the RGB color data units, data on luminance levels indicated by the oblique line portion is present for at least numbers of pixels indicated by the oblique line portion. Hereinafter, the numbers of pixels included in the oblique line portion are referred to as the “overlapping frequency”.

<1.3.1 Corrections to Luminance Levels>

In the present embodiment, corrections to luminance levels are made for each color of RGB such that an overlapping frequency of luminance levels between RGB color data units for one frame is maximized. At that time, the corrections are made such that, for each of the RGB color data units, the luminance level after a correction is higher than that before the correction or the luminance level before a correction is equal to the luminance level after the correction.

For a specific processing procedure, first, the input image luminance level analyzing circuit 120 obtains luminance level distributions of respective RGB color data units based on input image signals. Then, the correction coefficient calculating circuit 140 calculates correction coefficients P(R), P(G), and P(B) by which an overlapping frequency of luminance levels between the RGB color data units for one frame is maximized when the luminance levels of the RGB color data units are assumed to be corrected by the following equations (11) to (13). Note that the correction coefficients P(R), P(G), and P(B) are values greater than or equal to one.

Ia(R)=Ib(R)×P(R) (11)

Ia(G)=Ib(G)×P(G) (12)

Ia(B)=Ib(B)×P(B) (13)

where Ia(R) is the luminance level of red data after a correction, Ia(G) is the luminance level of green data after a correction, and Ia(B) is the luminance level of blue data after a correction; Ib(R) is the luminance level of the red data before the correction, Ib(G) is the luminance level of the greed data before the correction, and Ib(B) is the luminance level of the blue data before the correction; and P(R) is the correction coefficient of the red data, P(G) is the correction coefficient of the green data, and P(B) is the correction coefficient of the blue data.

After the calculation of the correction coefficients P(R), P(G), and P(B) by the correction coefficient calculating circuit 140, the image signal correcting circuit 160 multiples luminance levels (of pixel data units) indicated by the input image signals by the correction coefficients P(R), P(G), and P(B) for each color of RGB, to correct the luminance levels and outputs gray scale signals DV indicating gray scale values corresponding to the luminance levels obtained after the corrections.

<1.3.2 Adjustments to the Amounts of Lights Emitted from the Backlight>

After the calculation of the correction coefficients P(R), P(G), and P(B) by the correction coefficient calculating circuit 140, the amount-of-backlight-light control circuit 600 calculates amounts of lights emitted from the LEDs 53R, 53G, and 53B for the respective RGB colors in the backlight 500, based on the following equations (21) to (23):

Ba(R)=Bb(R)/P(R) (21)

Ba(G)=Bb(G)/P(G) (22)

Ba(B)=Bb(B)/P(B) (23)

where Ba(R) is the amount of light emitted from the red LEDs 53R, Ba (G) is the amount of light emitted from the green LEDs 53G, and Ba(B) is the amount of light emitted from the blue LEDs 53B; and Bb(R) is the amount of light emitted (the maximum amount of light emitted) from the red LEDs 53R for when a correction to a luminance level is not made, Bb(G) is the amount of light emitted (the maximum amount of light emitted) from the green LEDs 53G for when a correction to a luminance level is not made, and Bb(B) is the amount of light emitted (the maximum amount of light emitted) from the blue LEDs 53B for when a correction to a luminance level is not made.

The amount-of-backlight-light control circuit 600 outputs backlight control signals S(R), S(G), and S(B) based on the amounts of lights emitted Ba(R), Ba(G), and Ba(B) calculated in the above-described manner. Then, based on the backlight control signals S(R), S(G), and S(B), lights are radiated onto the display unit 200 from the LEDs 53R, 53G, and 53B for the respective RGB colors in the backlight 500. Note that such adjustments to the amounts of lights emitted from the backlight 500 are made at timing at the point of the start of each frame or immediately before the start of each frame.

### 1.3.3 Specific Examples

Next, specific examples of corrections to luminance levels and adjustments to the amounts of lights emitted from the backlight are shown. Here, description is made assuming that digital image signals DA in which luminance level distributions of respective RGB color data units are such as those shown in FIGS. 3A to 3C are inputted.

The correction coefficient calculating circuit 140 calculates correction coefficients P(R), P(G), and P(B) by which an overlapping frequency of luminance levels between RGB color data units for one frame is maximized. For example, they are calculated as “P(R)=2, P(G)=1, and P(B)=1.2”. In the image signal correcting circuit 160, based on the correction coefficients P(R), P(G), and P(B), the luminance levels of respective pixel data units indicated by input image signals are corrected. Specifically, for each red pixel data the luminance level is corrected to double, and for each blue pixel data the luminance level is corrected to 1.2 times. Note that for each green pixel data there is no change in luminance level before and after a correction.

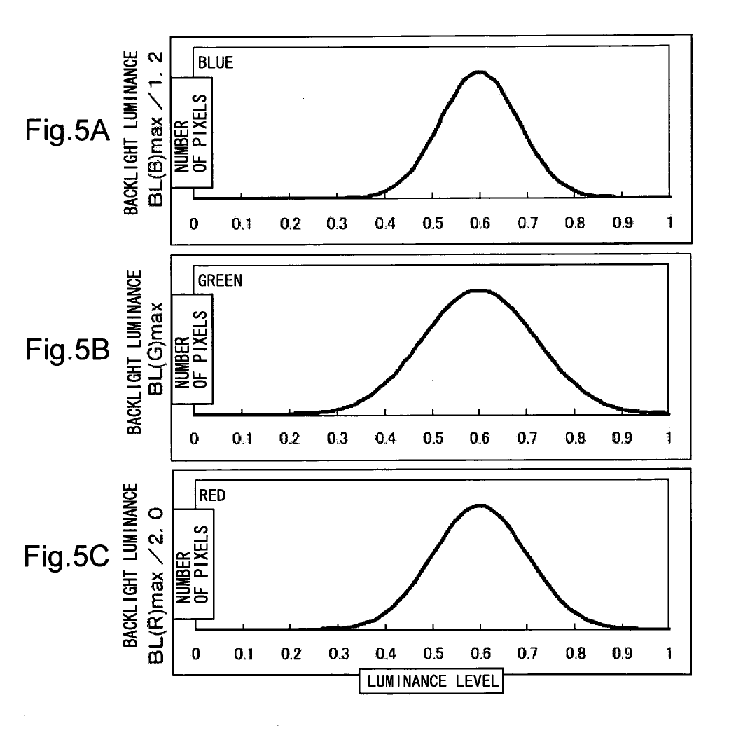

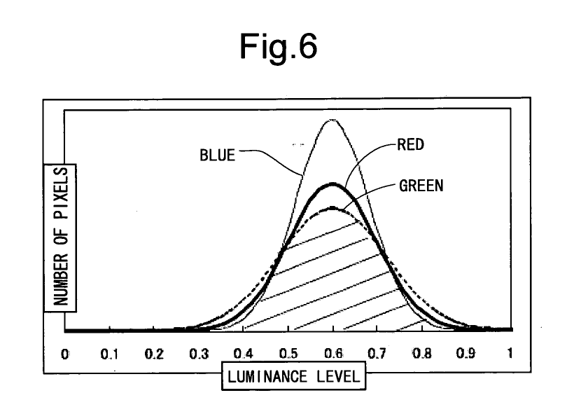

By correcting the luminance levels of respective RGB color pixel data units in the above-described manner, luminance level distributions of the respective RGB color data units become those shown in FIGS. 5A to 5C. As a result, an overlapping frequency of luminance levels between the RGB colors is such as that indicated by an oblique line portion in FIG. 6. Since, before making corrections to the luminance levels, an overlapping frequency of luminance levels between the RGB colors is such as that indicated by the oblique line portion in FIG. 4, it is grasped that the overlapping frequency is increased by the corrections to the luminance levels.

In the amount-of-backlight-light control circuit 600, based on the correction coefficients P(R), P(G), and P(B), amounts of lights emitted from the LEDs for the RGB colors in the backlight 500 are calculated. Specifically, the amount of light emitted from the red LEDs 53R is calculated to be “one half” of the maximum amount of light emitted, the amount of light emitted from the green LEDs 53G is calculated to be an amount of light emitted that is equal to the maximum amount of light emitted, and the amount of light emitted from the blue LEDs 53B is calculated to be “1/1.2” of the maximum amount of light emitted. Then, backlight control signals S(R), S (G), and S(B) are transmitted from the amount-of-backlight-light control circuit 600 to the backlight 500 such that lights are radiated from the LEDs for the RGB colors based on the calculated amounts of lights emitted.

<1.4 Effects>

As described above, according to the present embodiment, correction coefficients P(R), P(G), and P(B) are calculated by the correction coefficient calculating circuit 140 such that an overlapping frequency on the basis of luminance level distributions of data units of three RGB colors is maximized. Then, by multiplying luminance levels of the RGB color data units by the correction coefficients P(R), P(G), and P(B) of the respective RGB colors, luminance levels after corrections are obtained for the respective RGB color data units. With the corrections to the luminance levels, a difference in luminance level distribution between the RGB colors is reduced. Hence, a difference in color nuance between when a display image is seen from a front direction and when the display image is seen from a oblique direction is reduced. In this manner, a liquid crystal display device capable of suppressing a shift in color nuance depending on the visual angle is provided. Moreover, along with the corrections to the luminance levels, the amounts of lights emitted from the backlight 500 are adjusted. Specifically, for the LEDs for the respective colors in the backlight 500, an amount of light emitted (an intensity of light to be radiated) is obtained by dividing the maximum amount of light emitted by a correction coefficient. Hence, intensities of lights are adjusted such that changes in luminance levels indicated by image signals and changes in the intensities of lights radiated from the backlight 500 are mutually cancelled out. Accordingly, while a contrast feeling obtained from a display image is increased, a shift in color nuance depending on the visual angle is suppressed.

Upon the above-described corrections to luminance levels, each correction coefficient is calculated such that the luminance level after a correction is higher than that before the correction or the luminance level before a correction is equal to the luminance level after the correction. In other words, the luminance levels of the respective colors are not reduced by corrections. Here, if the luminance level of a certain color is reduced by a correction, then the intensity of light radiated from the backlight 500 needs to be increased; however, there is an upper limit to the intensity of light that can be radiated. Thus, when the luminance level is reduced by a correction to less than a predetermined value, the intensity of light cannot be increased to a desired intensity. Regarding this point, according to the present embodiment, since adjustments are made so as to reduce the intensities of lights, the intensities of lights radiated from the backlight 500 are adjusted such that changes in luminance levels indicated by image signals and changes in the intensities of lights radiated from the backlight 500 are reliably cancelled out. Accordingly, a contrast feeling obtained from a display image is reliably increased.

<1.5 Variants>

<1.5.1 First Variant>

Although in the above-described first embodiment upper limit values are not set for the values of correction coefficients, in the present variant, upper limit values are set for the values of correction coefficients. This will be described below. Note that lower limit values of the values of correction coefficients are “1”, as with the first embodiment.

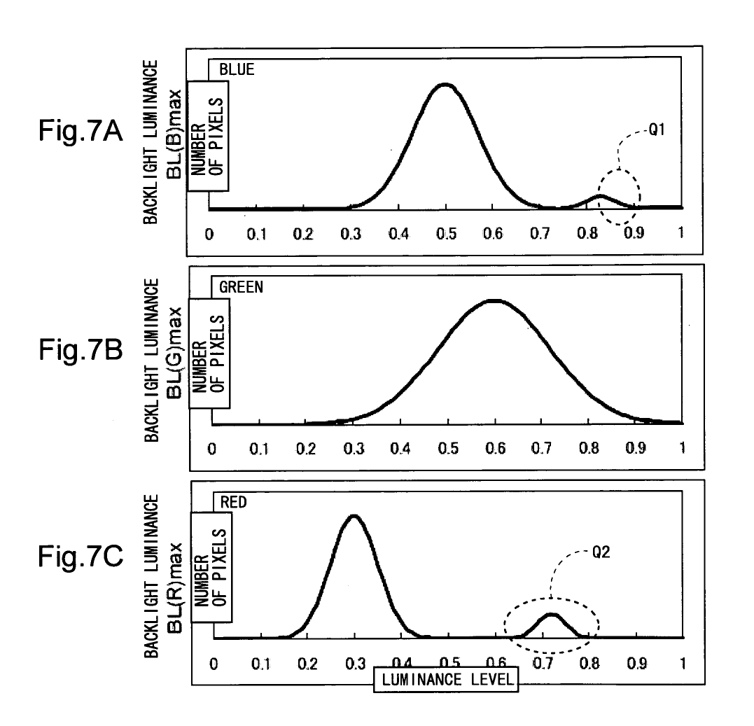

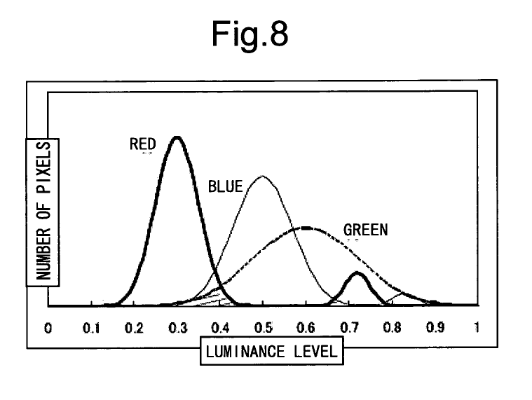

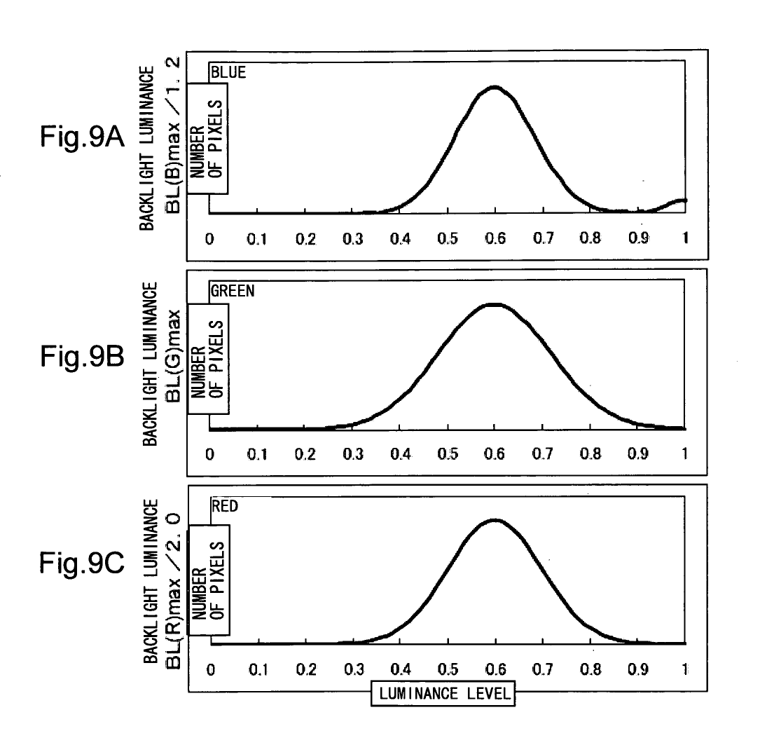

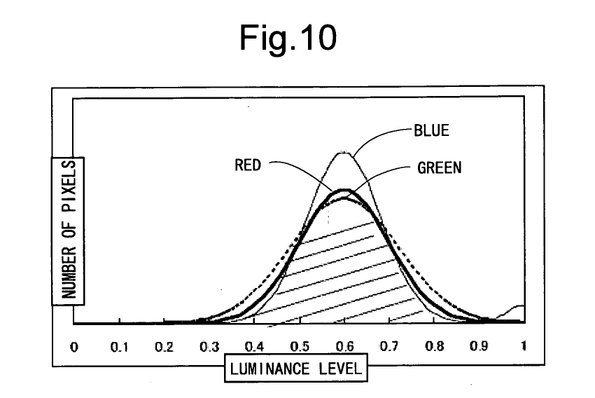

For example, when digital image signals DA in which luminance level distributions of respective RGB color data units are such as those shown in FIGS. 7A to 7C are inputted, an overlapping frequency of luminance levels between RGB colors is such as that indicated by an oblique line portion in FIG. 8. Here, when corrections to luminance levels are made by the configuration according to the first embodiment, luminance level distributions of the respective RGB color data units after corrections are such as those shown in FIGS. 9A to 9C. As a result, an overlapping frequency of luminance levels between the RGB colors is such as that indicated by an oblique line portion in FIG. 10. Accordingly, by the corrections to luminance levels, the overlapping frequency of luminance levels between the RGB colors increases. Here, taking a look at data indicated by reference numeral Q1 in FIG. 7A, data obtained after correcting the luminance levels of the data is not included in FIG. 9A. Similarly, for data indicated by reference numeral Q2 in FIG. 7C, data obtained after correcting the luminance levels of the data is not included in FIG. 9C. The reason for this is that for the aforementioned data the luminance levels after corrections have a value exceeding “1”. For example, for data among the data indicated by reference numeral Q2 in FIG. 7C that has a luminance level of “0.7”, since the correction coefficient P(R) is “2”, the luminance level after a correction is “1.4”. Accordingly, for data whose luminance level before a correction is greater than “1/correction coefficient”, the luminance level after the correction exceeds “1”. Hence, when data whose luminance level before a correction is greater than “1/correction coefficient” is included, desired “corrections to luminance levels” are not reflected in gray scale signals DV (outputted from the gray scale signal generating portion 100).

In view of the above, in the present variant, upper limit values are set for the values of correction coefficients for each color of RGB. Specifically, when the maximum value of the luminance level of each color data unit before a correction is Imax, an upper limit value of a correction coefficient of each of the RGB colors is set to “1/Imax”. As described above, lower limit values of the values of correction coefficients are “1”. Therefore, correction coefficients P(R), P(G), and P(B) of the respective RGB colors are set to values in a range satisfying the following equations (31) to (33):

1/Imax(R)≧P(R)≧1 (31)

1/Imax(G)≧P(G)≧1 (32)

1/Imax(B)≧P(B)≧1 (33)

where Imax(R) is the maximum value of the luminance level of red data before a correction, Imax(G) is the maximum value of the luminance level of green data before a correction, and Imax(B) is the maximum value of the luminance level of blue data before a correction.

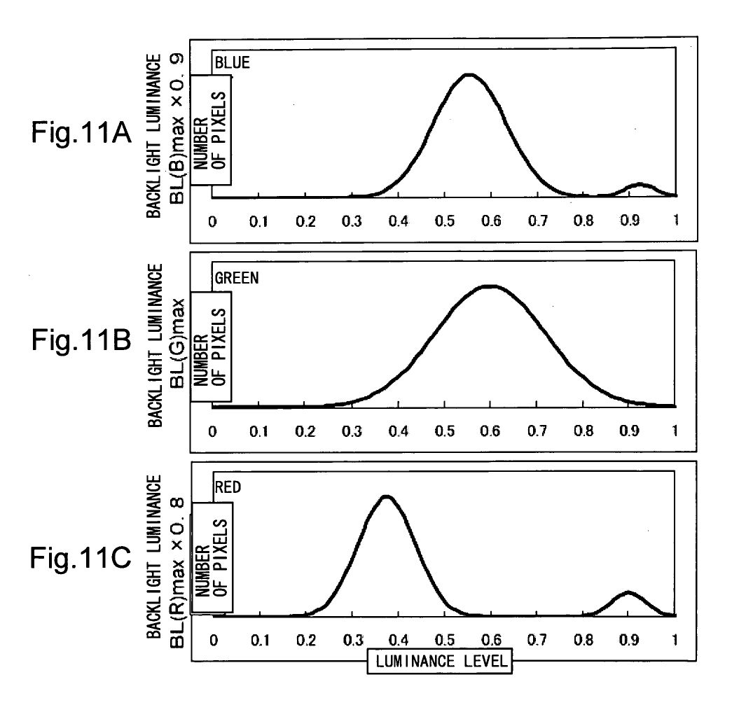

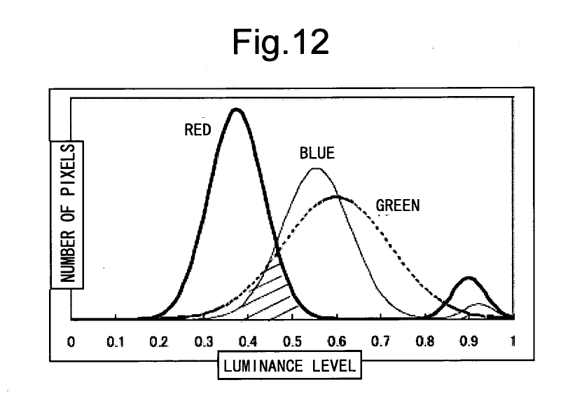

When correction coefficients are calculated so as to satisfy the aforementioned equations (31) to (33) when digital image signals DA in which luminance level distributions of respective RGB color data units are such as those shown in FIGS. 7A to 7C are inputted, they are calculated as “P(R)=1/0.8, P(G)=1, and P(B)=1/0.9”. Then, based on the correction coefficients P(R), P(G), and P(B), the luminance levels of respective RGB color pixel data units are corrected; as a result, luminance level distributions of the respective RGB color data units become those shown in FIGS. 11A to 11C. At this time, as to pixel data units included in the luminance level distributions shown in FIGS. 7A to 7C, data units obtained after correcting the luminance levels are all included in FIGS. 11A to 11C. Also, an overlapping frequency of luminance levels between the RGB colors is such as that indicated by an oblique line portion in FIG. 12. Since, before making corrections to the luminance levels, an overlapping frequency of luminance levels between the RGB colors is such as that indicated by the oblique line portion in FIG. 8, it is grasped that the overlapping frequency is increased by the corrections to the luminance levels.

According to the present variant, luminance levels indicated by image signals after corrections do not exceed “1”, i.e., luminance levels indicated by image signals after corrections do not exceed the maximum values of displayable luminance levels. Accordingly, an event that “corrections to luminance levels are not reflected in a display image” does not occur and an image on the basis of luminance levels obtained after corrections is reliably displayed.

<1.5.2 Second Variant>

Although in the above-described embodiment, lights with an equal intensity are radiated onto the entire display unit 200 for each color of RGB, the present invention is not limited thereto. The configuration may be such that the display unit 200 is virtually divided into a plurality of regions and corrections to luminance levels are made using different correction coefficients for the divided regions, respectively, and lights with different intensities are radiated onto the divided regions, respectively, for each of RGB colors.

According to the present variant, corrections to luminance levels are made for each region of divided regions such that an overlapping frequency of luminance levels between the RGB colors is maximized. Therefore, a shift in color nuance depending on the visual angle is further reduced and accordingly a liquid crystal display device with a wider viewing angle is implemented.

### 2. Second Embodiment

<2.1 Summary of Configuration and Operation>

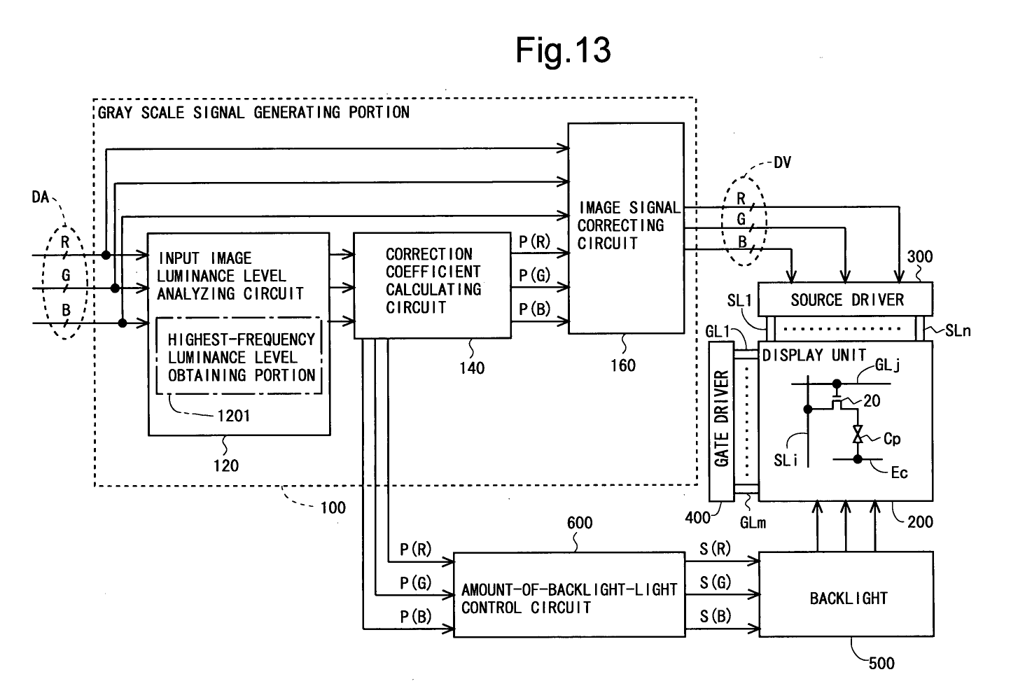

FIG. 13 is a block diagram showing an overall configuration of a liquid crystal display device according to a second embodiment of the present invention. In the present embodiment, the configuration in a gray scale signal generating portion 100 is different from that in the first embodiment and thus will be described below.

Unlike the first embodiment, in the present embodiment, a highest-frequency luminance level obtaining portion 1201 is included in an input image luminance level analyzing circuit 120. Also, an overlapping frequency obtaining portion is not included in a correction coefficient calculating circuit 140. The highest-frequency luminance level obtaining portion 1201 obtains, for each of RGB color data units, a luminance level at which the number of pixels is largest (hereinafter, referred to as the “highest-frequency luminance level”), based on luminance level distributions obtained in the same manner as in the first embodiment. The correction coefficient calculating circuit 140 calculates, based on the highest-frequency luminance levels obtained by the highest-frequency luminance level obtaining portion 1201, correction coefficients P(R), P(G), and P(B) for correcting the luminance levels of the respective RGB color data units and adjusting the amounts of lights emitted from a backlight 500, and outputs them. An image signal correcting circuit 160 corrects, based on the correction coefficients P(R), P(G), and P(B) calculated by the correction coefficient calculating circuit 140, the luminance levels of respective RGB color data units on the basis of digital image signals DA, and outputs gray scale signals DV indicating gray scale values corresponding to the luminance levels obtained after the corrections.

<2.2 Corrections to Luminance Levels>

Next, corrections to luminance levels in the present embodiment will be described. In the present embodiment, corrections to luminance levels are made for each color of RGB such that highest-frequency luminance levels for one-frame data match between the three RGB colors. At that time, for each of RGB color data units, the luminance level after a correction is to be higher than the luminance level before the correction or the luminance level before a correction is to be equal to the luminance level after the correction.

For a specific processing procedure, first, the input image luminance level analyzing circuit 120 obtains luminance level distributions of respective RGB colors. Then, the highest-frequency luminance level obtaining portion 1201 in the input image luminance level analyzing circuit 120 obtains highest-frequency luminance levels of respective RGB color data units based on the luminance level distributions. Furthermore, the correction coefficient calculating circuit 140 calculates correction coefficients P(R), P(G), and P(B) by the following equations (41) to (43):

P(R)=Kmax/K(R) (41)

P(G)=Kmax/K(G) (42)

P(B)=Kmax/K(B) (43)

where K(R) is the highest-frequency luminance level of red data, K(G) is the highest-frequency luminance level of green data, and K(B) is the highest-frequency luminance level of blue data; and Kmax is the maximum value of K(R), K(G), and K(B).

After the calculation of the correction coefficients P(R), P(G), and P(B), in the image signal correcting circuit 160, by multiplying luminance levels (of pixel data units) indicated by input image signals by the correction coefficients P(R), P(G), and P(B) for each color of RGB, the luminance levels are corrected.

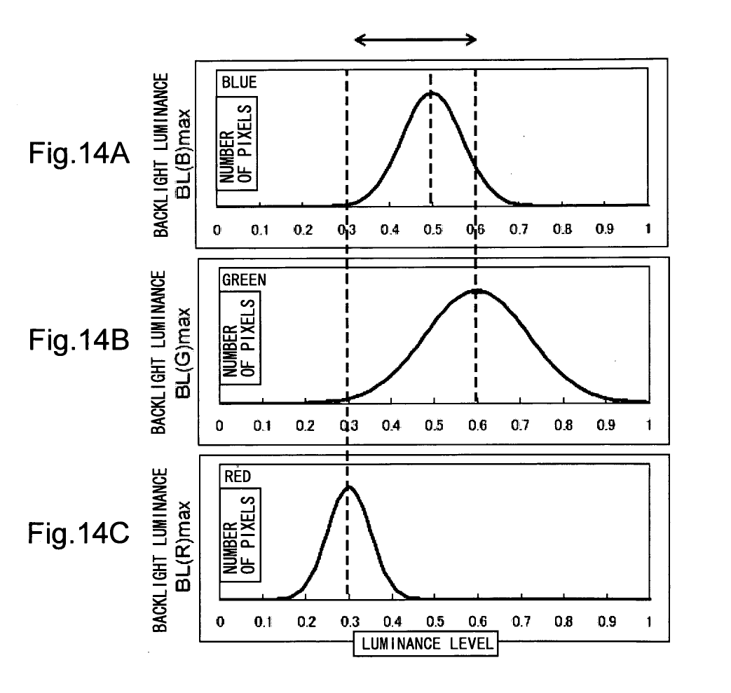

Now, a specific example will be described assuming that digital image signals DA in which luminance level distributions of respective RGB color data units are such as those shown in FIGS. 14A to 14C are inputted. According to the luminance level distributions shown in FIGS. 14A to 14C, the highest-frequency luminance level of red data is “0.3”, the highest-frequency luminance level of green data is “0.6”, and the highest-frequency luminance level of blue data is “0.5”. These highest-frequency luminance levels are obtained by the highest-frequency luminance level obtaining portion 1201 in the input image luminance level analyzing circuit 120.

The correction coefficient calculating circuit 140 calculates correction coefficients P(R), P(G), and P(B) by the aforementioned equations (41) to (43) based on the highest-frequency luminance levels of the respective RGB color data units and a maximum value of the highest-frequency luminance levels. Here, they are calculated as “P(R)=2, P(G)=1, and P(B)=1.2”. Then, in the image signal correcting circuit 160, as with the first embodiment, the luminance levels of pixel data units indicated by input image signals are corrected, based on the correction coefficients P(R), P(G), and P(B).

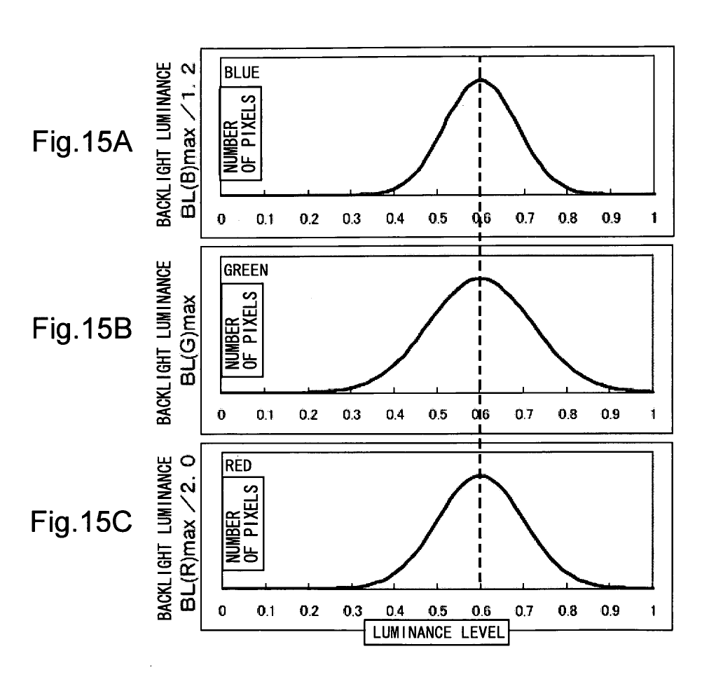

By correcting the luminance levels of respective RGB color pixel data units in the above-described manner, luminance level distributions of the respective RGB color data units become those shown in FIGS. 15A to 15C. As a result, for all the RGB color data units, a highest-frequency luminance level is to be “0.6”.

Note that adjustments to the amounts of lights emitted from the backlight 500 are the same as those in the first embodiment and thus description thereof is not given.

<2.3 Effects>

As described above, according to the present embodiment, by dividing the maximum value of highest-frequency luminance levels of data units of three RGB colors by a highest-frequency luminance level of each of the RGB colors, correction coefficients P(R), P(G), and P(B) of the respective RGB colors are calculated. In this way, since correction coefficients are calculated using only highest-frequency luminance levels of the respective RGB colors, the configuration of the correction coefficient calculating circuit 140 can be made relatively simple.

<2.4 Variants>

<2.4.1 First Variant>

Although in the second embodiment, upper limit values are not set for the values of correction coefficients, in the present variant, upper limit values are set for the values of correction coefficients. This will be described below.

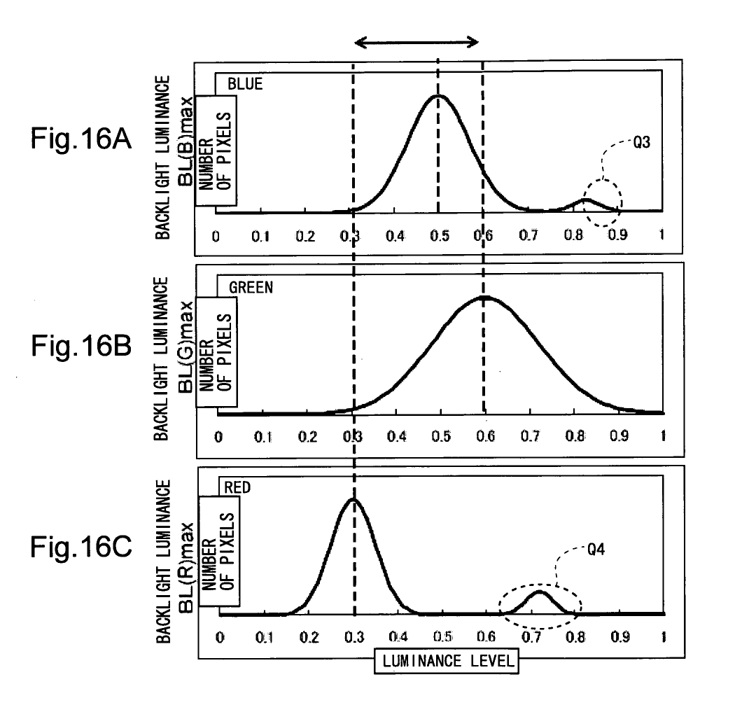

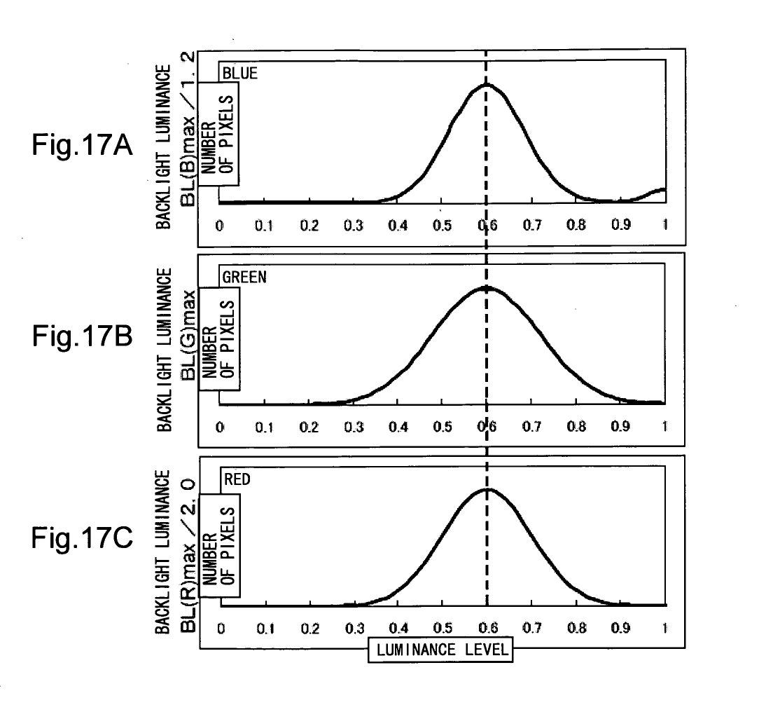

For example, when digital image signals DA in which luminance level distributions of respective RGB color data units are such as those shown in FIGS. 16A to 16C are inputted, the highest-frequency luminance level of red data is “0.3”, the highest-frequency luminance level of green data is “0.6”, and the highest-frequency luminance level of blue data is “0.5”. Here, when corrections to luminance levels are made by the configuration according to the second embodiment, the highest-frequency luminance levels of the respective RGB color data units after the corrections become all “0.6” as shown in FIG. 17.

Here, taking a look at data indicated by reference numeral Q3 in FIG. 16A, data obtained after correcting the luminance levels of the data is not included in FIG. 17A. Similarly, for data indicated by reference numeral Q4 in FIG. 16C, data obtained after correcting the luminance levels of the data is not included in FIG. 17C. As such, for data whose luminance level before a correction is greater than “1/correction coefficient”, the luminance level after the correction exceeds “1”. Hence, when data whose luminance level before a correction is greater than “1/correction coefficient” is included, desired “corrections to luminance levels” are not reflected in gray scale signals DV (outputted from the gray scale signal generating portion 100).

Therefore, in the present variant, upper limit values are set for the values of correction coefficients for each color of RGB. Specifically, as with the first variant in the first embodiment, correction coefficients P(R), P(G), and P(B) of the respective RGB colors are set to values in a range satisfying the aforementioned equations (31) to (33).

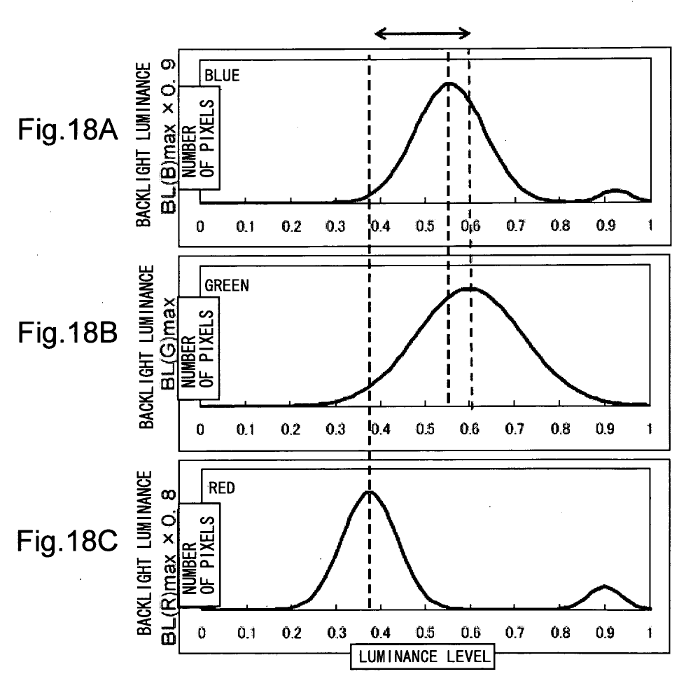

As a result of setting upper limit values for the correction coefficients in the above-described manner, the correction coefficients of the respective RGB colors become “P(R)=1/0.8, P(G)=1, and P(B)=1/0.9”. Accordingly, luminance level distributions of the respective RGB color data units after making corrections to luminance levels become those shown in FIGS. 18A to 18C. At this time, as to pixel data units included in the luminance level distributions shown in FIGS. 16A to 16C, data units obtained after correcting the luminance levels are all included in FIGS. 18A to 18C.

According to the present variant, luminance levels indicated by image signals after corrections do not exceed the maximum values of displayable luminance levels. Accordingly, an event that “corrections to luminance levels are not reflected in a display image” does not occur and an image on the basis of luminance levels obtained after corrections is reliably displayed.

<2.4.2 Second Variant>

Although in the second embodiment, corrections to luminance levels are made such that highest-frequency luminance levels for one-frame data match between three RGB colors, the present invention is not limited thereto. Instead of the highest-frequency luminance level obtaining portion 1201 in the second embodiment, an average luminance level obtaining portion that obtains, as an average luminance level, an average value of luminance levels for each of RGB colors may be included. Then, corrections to luminance levels may be made such that average luminance levels for one-frame data match between the three RGB colors.

In the present variant, as with the above-described second embodiment, the configuration of the correction coefficient calculating circuit 140 can be made relatively simple.

1. A liquid crystal display device that has a display unit including a plurality of pixels and a backlight that radiates lights of a plurality of primary colors onto the display unit from a back of the display unit; receives image signals indicating luminance levels of the plurality of primary colors for each pixel from an external source; and displays an image based on the plurality of primary colors on the display unit based on the image signals, the liquid crystal display device comprising:
a luminance level distribution obtaining portion that obtains, based on the image signals, number-of-pixel distributions by luminance level that represent distributions of the number of pixels by luminance level for the respective plurality of primary colors;
an image signal correcting portion that corrects, for each color of the plurality of primary colors, the luminance levels indicated by the image signals such that a difference in the number-of-pixel distribution by luminance level between the plurality of primary colors is reduced, based on the number-of-pixel distributions by luminance level for the respective plurality of primary colors obtained by the luminance level distribution obtaining portion; and
a light emission intensity adjusting portion that adjusts, for each color of the plurality of primary colors, intensities of the lights radiated from the backlight, according to magnitudes of the corrections made to the luminance levels for each color of the plurality of primary colors by the image signal correcting portion, wherein
the light emission intensity adjusting portion adjusts the intensity of light radiated from the backlight such that the intensity of light is lowered for a primary color whose luminance level is corrected to be higher by the image signal correcting portion.

2. The liquid crystal display device according to claim 1, wherein the light emission intensity adjusting portion adjusts the intensity of light radiated from the backlight such that the intensity of light is heightened for a primary color whose luminance level is corrected to be lower by the image signal correcting portion.

3. The liquid crystal display device according to claim 1, further comprising a correction coefficient calculating portion that calculates, for each color of the plurality of primary colors, correction coefficients for determining the magnitudes of the corrections to the luminance levels, based on the number-of-pixel distributions by luminance level for the respective plurality of primary colors, wherein
the image signal correcting portion corrects, for each color of the plurality of primary colors, the luminance levels indicated by the image signals, based on the correction coefficients calculated for each color of the plurality of primary colors, and
the light emission intensity adjusting portion adjusts, for each color of the plurality of primary colors, intensities of the lights radiated from the backlight, based on the correction coefficients calculated for each color of the plurality of primary colors.

4. The liquid crystal display device according to claim 3, further comprising an overlapping frequency obtaining portion that obtains, as an overlapping frequency, numbers of pixels included in a region where, when the number-of-pixel distributions by luminance level for the respective plurality of primary colors are superimposed on one another, all of the plurality of primary colors overlap one another, wherein
the correction coefficient calculating portion calculates the correction coefficients such that the overlapping frequency is maximized.

5. The liquid crystal display device according to claim 3, further comprising a highest-frequency luminance level obtaining portion that obtains, for each color of the plurality of primary colors, a luminance level at which a number of pixels is largest, as a highest-frequency luminance level, based on the number-of-pixel distributions by luminance level for the respective plurality of primary colors, wherein
the correction coefficient calculating portion calculates the correction coefficients such that the highest-frequency luminance levels of the respective plurality of primary colors are equal to one another.

6. The liquid crystal display device according to claim 3, further comprising an average luminance level obtaining portion that obtains, for each color of the plurality of primary colors, an average value of luminance levels as an average luminance level, based on the number-of-pixel distributions by luminance level for the respective plurality of primary colors, wherein
the correction coefficient calculating portion calculates the correction coefficients such that the average luminance levels of the respective plurality of primary colors are equal to one another.

7. The liquid crystal display device according to claim 3, wherein the correction coefficient calculating portion calculates the correction coefficients such that luminance levels indicated by image signals after corrections made by the image signal correcting portion are higher or equal to luminance levels indicated by image signals before the corrections.

8. The liquid crystal display device according to claim 3, wherein the correction coefficient calculating portion calculates the correction coefficients under a condition that luminance levels indicated by image signals after corrections made by the image signal correcting portion are less than or equal to maximum values of luminance levels displayable on the display unit.

9. The liquid crystal display device according to claim 1, wherein
the backlight is configured to be able to radiate, for the plurality of primary colors, lights with different intensities onto a plurality of predetermined regions, respectively, which are included in the display unit,
the luminance level distribution obtaining portion obtains, for each region of the plurality of regions, number-of-pixel distributions by luminance level,
the image signal correcting portion corrects, for each region of the plurality of regions, the luminance levels indicated by the image signals, and
the light emission intensity adjusting portion adjusts, for each region of the plurality of regions, the intensities of the lights.
